(19) United States
(12) Patent Application Publication
(10) Pub. No.: US 2005/0059371 A1
(43) Pub. Date: Mar. 17, 2005

(54) Circuit arrangement, switching module comprising said circuit arrangement and use of switching module

(76) Inventors: Christian Block, Stainz (AT); Holger Fluhr, Graz (AT); Kurt Wiesbauer, Kalsdorf (AT); Johann Riedler, Deutschlandsberg (AT); Heinz Ragossnig, Gross St. Florian (AT); Heinz Florian, Bad Gams (AT); Gunther Greier, Graz-St. Peter (AT)

Correspondence Address: FISH & RICHARDSON PC, 225 FRANKLIN ST, BOSTON, MA, 02110, US

(21) Appl. No.: 10/490,753

(22) PCT Filed: Sep. 30, 2002
(86) PCT No.: PCT/DE02/03687

(30) Foreign Application Priority Data
Sep. 28, 2001 (DE) 101 47 985.9

(51) Int. Cl. H04B 1/18; H04B 1/16; H04B 1/06; H04B 7/00

(52) U.S. Cl. 455/217; 455/193.1; 455/269; 455/575.7; 455/562.1; 343/824; 343/893

(57) ABSTRACT

The invention relates to a circuit array with an antenna input (1), a signal input (2) and a signal output (3), a switch unit (4), in which the antenna input (1) is connected to a first protective device (6) against electrostatic discharges, wherein the first protective device (6) has an antenna input (111) and a switch output (112), which are connected to one another by a line (113), and in which a voltage-limiting element (114) is connected to a ground (8) in parallel to the line (113). The advantage of the circuit array of the invention is that the protective device (6) has a low insertion loss. The invention also relates to a circuit module as well as the use of the circuit module as a front-end module.

The invention relates to a circuit array with a switch unit, which has an antenna input, a signal input and a signal output. In addition, the switch unit has a control line, which can be used optionally to control the transfer of a connection between the antenna input and the signal input or the signal output. The antenna input of the circuit array is connected to a protective device against electrostatic discharges.

Circuit arrays of the type mentioned above are often used as multi-band front-end modules for mobile telephones. In this application, they are connected to the antenna of a mobile telephone at the antenna input. When the antenna comes into contact with an electrically-charged user, this can result in electrostatic discharge, also known under the name “electrostatic discharge (ESD)”. These electrostatic discharges can create voltage peaks that are capable of destroying the circuit array. Thus, it is necessary to equip circuit arrays of the type mentioned above with a device that protects against ESD.

Printed specification WO 00/57515 discloses circuit arrays of the type mentioned above that are equipped with a protective device against ESD. The protective device comprises an electric high-pass filter in which a capacitor is connected in series and an inductor is connected in parallel to the antenna input path.

A drawback of the known circuit array is that the ESD protective device only helps reduce the ESD impulse entering the circuit array directly through the antenna.

In addition to the impulse entering the circuit array directly through the antenna, an electrostatic discharge can also generate a high voltage in the circuit array through ground coupling. This can occur, for example, because the control input normally used in a circuit is arranged either on a high voltage (high) or on a low voltage (low). In this case, the high voltage (high) is defined, for example, by the fact that it lies 2.3 V above the ground voltage of the circuit array. Because, in the case of a mobile telephone, as with many other devices based on signal transmission via antennas, the signal input runs from the antenna to the system's ground, an electrostatic discharge can also directly affect the ground voltage of the circuit array in a circuit array of the type mentioned above. As a result of the directly coupling of a control line to ground through the “high” condition, the voltage impulse resulting from an electrostatic discharge can not only affect the path, via the antenna, but also the circuit array, via the control line. The known circuit array is not protected against these effects.

In addition, the high-pass filter used in the known circuit array has the characteristic of being a very simply designed filter that allows all frequency components of a signal, beginning with a certain cutoff frequency, to pass through it virtually unimpeded. In general, however, only a very narrow frequency range is relevant to the further processing of the signal received by the antenna in a mobile telephone. For example, frequencies between 1 and 2 GHz are used in mobile telephones based on the GSM, PCN or PCS standard. All other frequencies received by the antenna tend to be interfering and, therefore, must be filtered out. Accordingly, at least one band-pass filter is needed to make the signal captured by the circuit array mentioned above capable of being processed for a mobile telephone.

The high-pass filter arranged in the known circuit array can only cut off frequencies below a certain cutoff frequency. For this reason, at least one filter circuit must be connected downstream from this filter, in order to remove the frequency range relevant to the mobile telephone from the signals received by the antenna.

Accordingly, an advantage of the known circuit array is that the high-pass filter circuit used to protect against ESD has an insertion loss, causing the wanted signals to undergo a certain attenuation, although cutting of the transmitted frequency band does not take place. Accordingly, a disadvantage of the known circuit array, operating in conjunction with the filtration, which is also needed, is a generally high insertion loss.

The goal of this invention, therefore, is to provide a circuit array of the type mentioned above, in which the protective device against electrostatic discharges has a low insertion loss.

This goal is achieved through a circuit array according to claim 1. Additional advantageous embodiments of the invention, as well as a circuit module and the use of the circuit module can be seen from the dependent claims.

A circuit array is described that contains a switch unit with an antenna input, a signal input, and a signal output. The switch unit is suitable for electrically connecting the antenna input with either the signal input or the signal output. Additionally, the antenna input is connected to a first protective device against electrostatic discharges.

The first protective device against electrostatic discharges has an antenna input and a switch output, wherein the switch output is connected to the antenna input of the switch unit. The antenna input of the protective device and the switch output of the protective device are connected to a line. A voltage-limiting element, which can be a varistor, a spark gap or a charge eliminator, is connected in parallel to ground. The voltage-limiting element is connected to a ground.

With the aid of the voltage-limiting element, excess voltage applied to the antenna input of the protective device can be discharged to ground. This means that the key function of the protective device consists of limiting the voltage applied to the antenna input of the switch unit.

An advantage of the circuit array of the invention is that, as a result of the special design of the protective device, a filter function is omitted, which results in a low insertion loss in the first protective device.

However, the protective mechanism of the circuit array can be improved by connecting an inductor in parallel to the voltage-limiting element. The inductor is in turn connected to the ground. The inductor connected in parallel to the voltage-limiting element is suitable for discharging very low frequencies to ground. Thus, as a result of the protective device, high frequencies are transmitted from the antenna input to the switch unit without being modified.

It is also advantageous if a first inductor is connected between the antenna input and the voltage-limiting element and a second inductor between the voltage-limiting element and the switch output, both being connected in series to the line. As a result of these two additional inductors, the impedance of the protective device can be adjusted to conform to the normal value for high-frequency ranges, 50 Ω.

In particular, a low insertion loss in the first protective device of <0.3 dB can be achieved though suitable selection of the inductances between 0 and 47 nH.

In addition, a control line that controls the switch position of the switch unit can be arranged in the switch unit.

In addition, protection against excess voltage (ESD protection) can be further improved by also connecting the control line of the circuit array with a second protective device against electrostatic discharges. As a result, the excess voltage input into the switch unit through ground couplings and applied to the control line can be reduced in an especially effective manner.

The protective devices against electrostatic discharges are advantageously connected to a ground connection, into which the excess voltage from the electrostatic discharges can be discharged.

The switch unit can, for example, be a voltage-controlled switch, such as the type normally used in mobile telephone because of its low power consumption. In particular, a gallium-arsenide switch can be used as the switch unit.

The switch unit can also have multiple signal inputs and outputs. Accordingly, multiple control lines are needed.

The gallium-arsenide switch can also be provided with a decoder, which can be used to reduce the number of control lines. Such a decoder normally requires a power supply, which is connected via a supply line. The ESD protection of such a circuit can be improved even further by connecting the supply line to a third protective device against electrostatic discharges.

In addition, a circuit module is specified that contains a circuit array according to the invention. The circuit module also contains a multilayer ceramic substrate with integrated passive components, which form electric frequency filters. These frequency filters are assigned to the signal inputs or outputs. The switch unit, which can be implemented with the aid of PIN diodes or in the form of a gallium-arsenide switch, for example, is arranged on the upper side of the multilayer ceramic substrate. Furthermore, the first and second protective devices against electrostatic discharges are integrated into the circuit module.

The circuit array can also contain frequency filters that are assigned to individual signal inputs or signal outputs. They are especially suitable for filtering the frequencies received by the antenna on a mobile telephone in such a way that the signals conducted and filtered through the signal output can be processed further by the mobile telephone. The same applies to the signal inputs of the circuit array, which, in a mobile telephone, are used to transmit the voice signals generated in the mobile telephone to a receiver via the antenna.

The use of a varistor, which is connected in parallel to the control line and is also connected to the ground potential, represents another option that can be considered for a second protective device against electrostatic discharges. Such a varistor has a very low resistance beginning at a certain cutoff voltage, so that excess voltage can be diverted to ground. Varistors with low switching voltage are especially suitable, because in this case the residual voltage that occurs in a voltage impulse and loads the circuit array is lowest. For this reason, it is advisable to use varistors with a varistor voltage of between 4 and 20 V. Accordingly, the terminal voltage in a voltage impulse that loads the circuit array is about 8 to about 50 V. As a result, the circuit array can be reliably protected against destruction in the event of an ESD impulse.

Another possibility is to use a switch spark gap or a Z-diode as a second protective device against electrostatic discharges.

The invention also specifies a circuit array in which the antenna input is connected to an antenna, in which the signal output is connected to a receiving amplifier of a mobile telephone, and in which the signal input is connected to a transmission amplifier of a mobile telephone.

In addition, a circuit module is specified which contains a circuit array according to the invention. The circuit module also contains a multilayer ceramic substrate with integrated passive components, which form electric frequency filters. These frequency filters are assigned to the signal inputs or outputs. The switch unit, which can, for example, be implemented with the aid of PIN diodes or in the form of a gallium-arsenide switch, is arranged on the upper side of the multilayer ceramic substrate. In addition, the first and, if applicable, second protective device against electrostatic discharges is integrated into the circuit module.

An advantage of the circuit module is that, as a result of the integration of the passive components into the ceramic substrate, as well as the integration of the protective device into the circuit module, a high degree of integration is achieved, which advantageously affects the space requirements of the circuit module. The integration of the first and, if applicable, second protective device into the circuit module can occur, for example, by mounting these components onto the surface of the ceramic substrate, adjacent to the switch unit.

In particular, it is also advantageous to use the circuit module as a front-end module in a mobile telephone.

In the following, the invention is explained in greater detail on the basis of example embodiments and the corresponding diagrams.

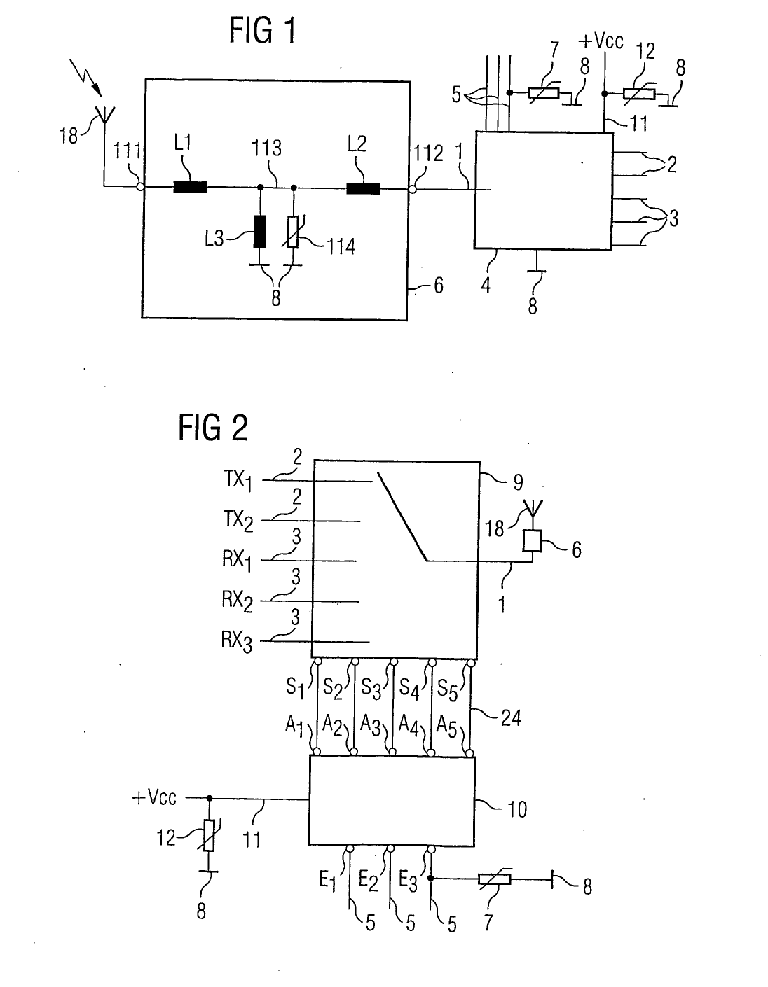

FIG. 1 shows, as an example, a circuit array according to the invention in a basic circuit diagram.

FIG. 2 shows, as an example, another circuit array according to the invention in a basic circuit diagram.

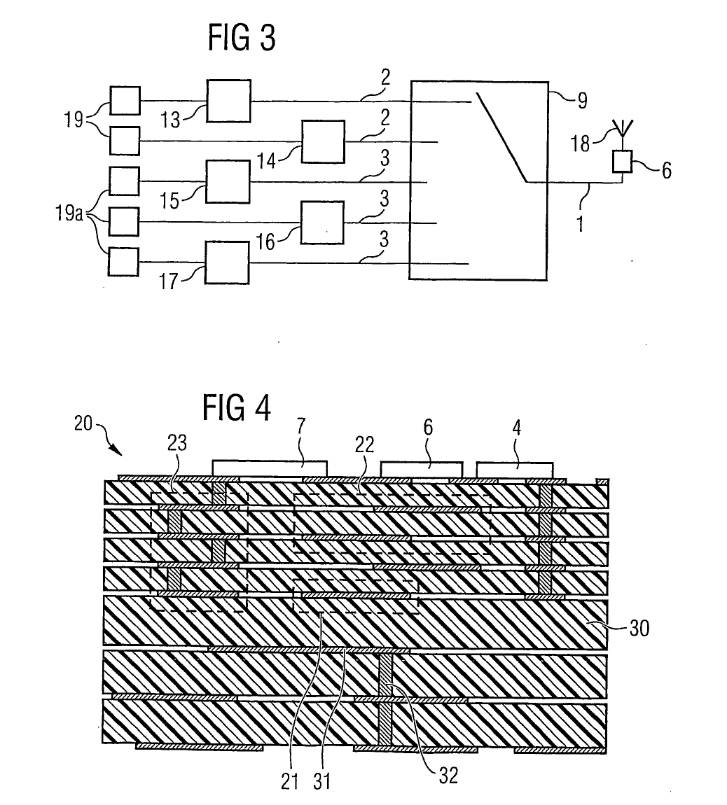

FIG. 3 shows, in a basic circuit diagram, the use of the circuit array according to the invention in a mobile telephone.

FIG. 4 shows, as an example, the circuit module according to the invention in a schematic longitudinal section.

The same reference symbols refer to the same elements in all diagrams.

FIG. 1 shows a circuit array with a switch unit 4, which is provided with a ground 8. The switch unit 4 has an antenna input 1, which is connected to an antenna 18. The antenna input 1 is connected to a first protective device 6 against electrostatic discharges (indicated by the lighting symbol in FIG. 1). The switch unit 4 contains at least one control line 5, which controls the switching process for connecting the antenna input 1 with the signal inputs 2 or the signal outputs 3 of the switch unit 4. Three control lines 5 are shown in FIG. 1. At least one of these control lines is provided with a second protective device 7 against electrostatic discharges. This second protective device 7 is implemented in the form of a varistor, which is connected to the ground 8. The switch unit 4 depicted in FIG. 1 also has a decoder, for which a supply line 11 is required. The supply line 11 is connected to a supply voltage +Vcc. In addition, the supply line 11 is connected to a third protective device 12 against electrostatic discharges. The protective device 12 can, for example, be a varistor that is connected to the ground 8.

The first protective device 6 has an antenna input 111 and a switch output 112. The antenna input 111 and the switch output 112 are connected to one another by a line 1113. Two inductors L1 and L2 are connected in series to the line 1113. These two inductors L1 and L2 serve to adjust the impedance to a value of 50 Ω. Between the two inductors L1 and L2, another inductor L3 and a voltage-limiting element 114 branch off in a parallel circuit to the line 113. The voltage-limiting element 114 can be a varistor, for example. The inductor L3, as well as the varistor, are connected to the ground 8 of the circuit array. The varistor limits the voltage input into the switch unit 4. The switching voltage of the varistor, which should be between 4 and 8 V, is especially important at this point. The smaller the switching voltage of the varistor, the more effectively can excess voltage be diverted and therefore suppressed with regard to the switch unit 4. A varistor switching voltage of 6 V or less is advantageous. This also applies to the second and third protective device 7, 12. The switching voltage of the varistor is the residual voltage that remains from the high-voltage impulse and is conducted through the protective device to the switch unit 4.

The inductances in the first protective device preferably have the following values:
L1=from 0 to 5 nH
L2=from 0 to 5 nH
L3=from 0 to 47 nH

In particular, an insertion loss in the first protective device less than 0.3 dB can be achieved through suitable selection of the inductances (L1=1 nH, L2=1 nH, L3=47 nH).

FIG. 2 shows a voltage-controlled GaAs switch 9 with an antenna input 1, to which the antenna 18 is connected. The GaAs switch 9 has transmitter inputs TX₁ and TX₂ and receiver inputs RX₁, RX₂, and RX₃. The GaAs switch 9 is controlled through control inputs S₁, S₂, S₃, S₄, and S₅. Control takes place in that exactly one of the control inputs S₁, S₂, S₃, S₄, and S₅ is set to “high,” while the remaining control inputs are set to “low.” The number of inputs needed can be reduced using the decoder 10 connected to the GaAs switch 9. The decoder 10 can be a 1-decoder or a 5-decoder, for example. It has control inputs E₁, E₂, and E₃, as well as control outputs A₁, A₂, A₃, A₄, and A₅. The control outputs A₁, A₂, A₃, A₄, and A₅ are connected to the control inputs S₁, S₂, S₃, S₄, and S₅ of the GaAs switch 9 through control lines 24.

The control inputs E₁, E₂, and E₃ of the decoder 10 are connected to the control lines 5.

An example of the decoding of a logical signal applied to one of the inputs E₁, E₂, and E₃ of the decoder 10 into signals applied to the control inputs S₁, S₂, S₃, S₄, and S₅ of the GaAs switch 9 that are suitable for controlling the GaAs switch is described by the following translation table:

TABLE 1
Logical states of the control inputs S₁, S₂, S₃, S₄, and S₅ as a
factor of the logical states at the control inputs E₁, E₂,
and E₃. 1 signifies “high” and 0 signifies “low.”

| E₁ | E₂ | E₃ | → | S₁ | S₂ | S₃ | S₄ | S₅ |
|---|---|---|---|---|---|---|---|---|
| 0 | 0 | 0 | | 1 | 0 | 0 | 0 | 0 |
| 0 | 0 | 1 | | 0 | 1 | 0 | 0 | 0 |
| 0 | 1 | 0 | | 0 | 0 | 1 | 0 | 0 |
| 0 | 1 | 1 | | 0 | 0 | 0 | 1 | 0 |
| 1 | 0 | 0 | | 0 | 0 | 0 | 0 | 1 |

In this case, the transmitter inputs TX₁ and TX₂ correspond to the signal inputs from FIG. 1. The receiver inputs RX₁, RX₂, and RX₃ correspond to the signal outputs 3 from FIG. 1.

FIG. 3 depicts a circuit module with a GaAs switch 9, which has an antenna input 1 as well as two signal inputs 2 and three signal outputs 3. In addition, the circuit module has two low-pass filters 13, 14, wherein the low-pass filter 13 can be configured for the GSM frequency band and the low-pass filter 14 for the PCN/PCS frequency band. The GaAs switch 9 optionally connects one of the inputs/outputs 2, 3 with its antenna input 1. The circuit module also has band-pass filters 15, 16, 17, which are connected to the signal outputs 3. The band-pass filter 15 is adjusted to the GSM frequency, the band-pass filter 16 to the PCN frequency, and the band-pass filter 17 to the PCS frequency.

The signal inputs 2 of the GaAs switch 9 are electrically connected to transmitter amplifiers 19. The transmitter amplifiers 19, like the low-pass filters 13, 14, are adjusted to radio frequencies GSM and PCN/PCS, respectively. The signal outputs are electrically connected to receiver amplifiers 19a through the band-pass filters 15, 16, 17, wherein the receiver amplifiers 19a are adjusted to the frequency bands GSM, PCN and PCS, respectively. The antenna input 1 of the GaAs switch 9 is connected to an antenna 18. The signals received by the antenna 18 can now be fed, by means of the GaAs switch 9, into the band-pass filter 16, the band-pass filter 17 or the band-pass filter 18, where they are filtered according to the radio frequency used and further processed in amplifiers 19a. The signals supplied by the transmitter amplifiers 19 are filtered by the low-pass filters 13, 14 and optionally supplied to the antenna 18 for transmission of a signal.

FIG. 4 shows a circuit module with a multilayer ceramic substrate 20, into which passive components 21, 22, 23 are integrated. These passive components 21, 22, 23 can be resistors, capacitors 22, and inductors 23, for example. The multilayer ceramic substrate 20 can be designed according to a known manner. Stacked ceramic layers 30 separated by metallic layers 31 can be used as the multilayer ceramic substrate 20. A few of the metallic layers 31 are connected to one another through continuous contacts 32 running inside the ceramic layers 30. A switch unit 4, which, for example, can be a gallium-arsenide multiple switch assembled in flip-chip technology, is mounted on the upper side of the ceramic substrate 20.

The switch unit 4 can, for example, be secured and electrically contacted by means of gluing and additional wire-bonding. A GaAs multiple switch is preferably used as the switch unit 4. This type of switch can have an insertion loss of 0.8 dB in the frequency range between 1 and 2 GHz. It can be an integrated circuit with FET produced on a gallium-arsenide base, with its pin surfaces connected to the ceramic substrate 20 by soldering.

The switch unit 4 can also be attached to the multilayer ceramic substrate 20 and electrically bonded by means of wire bonding. Bonding by means of soldering is preferred when the switch unit 4 is to be used with an additional housing.

The passive components 21, 22, 23 can form the filters 13, 14, 15, 16, 17 required in accordance with FIG. 3.

In addition to the switch unit 4, the first protective device 6 and the second protective device 7 are also mounted onto the surface of the substrate 20. This accomplishes a high degree of integration for the circuit module according to the invention, which advantageously affects the space requirements of the circuit module.

Such a circuit module can be used in mobile telephones, for example, and it is for this reason that the advantageous use of the circuit module of the invention as a front-end module in a mobile radio device is also the subject matter of the invention.

The invention is not limited to the examples of the second and third protective device mentioned above; instead, all conceivable protective devices can be used in the circuit array of the invention. In addition, the circuit array or the circuit module is not limited to applications in mobile telephones.

### List of Reference Symbols

1 Antenna input
2 Signal input
3 Signal output
4 Switch unit
5 Control line
6, 7, 12 First, second, third protective device
8 Ground
9 Gallium-arsenide switch
10 Decoder
11 Supply line
13, 14 Low-pass filter
15, 16, 17 Band-pass filter
18 Antenna
19 Transmitter amplifier
19a Receiver amplifier
20 Multilayer ceramic substrate
21 Resistor
22 Capacitor
23 Inductor
24 Control line
30 Ceramic layers
31 Metallic layers
32 Continuous contacts
TX₁, TX₂ Transmitter inputs
RX₁, RX₂, RX₃ Receiver inputs
S₁, S₁₂, S₃, S₄, S₅ Control inputs of the switch
A₁, A₂, A₃, A₄, A₅ Control outputs of the decoder
E₁, E₂, E₃ Control inputs of the decoder
Vcc Supply voltage
111 Antenna input
112 Switch output
113 Line
114 Voltage-limiting element
L1, L2, L3 Inductors

1. A circuit array comprising:
a first antenna inputs;
a signal input;
a signal outputs;
a switch unit that selectively connects the antenna input to either the signal input or the signal output; and
a first protective device connected to the first antenna input the the first protective device comprising a second antenna input connected to the first antenna input by a conductor, the first protective device, comprising a voltage-limiting element connected to a ground and in parallel to the conductor.

2. The circuit array of claim 1, further comprising an inductor connected in parallel to the voltage-limiting element.

3. The circuit array of claim 1, further comprising:
a first inductor connected between the second antenna input and the voltage-limiting elements; and
a second inductor connected between the voltage-limiting element and the switch output, the first and the second inductors being connected in series with the conductor.

4. The circuit array of claim 1, wherein the first protective device has an insertion loss <0.3 dB.

5. The circuit array of claim 1, further comprising:
a control line that controls the switch unit, wherein the control line is connected to a second protective device.

6. The circuit array of claim 5, wherein the second protective device is connected to ground.

7. The circuit array of claim 1, wherein the switch unit comprises a voltage-controlled switch.

8. The circuit array of claim 7, wherein the switch unit comprises a gallium-arsenide switch.

9. The circuit array of claim 1, further comprising:
a decoder having a supply line connected to a third protective device.

10. The circuit array of claim 1, further comprising:
a frequency filter assigned and connected in series to a signal input or a signal output.

11. The circuit array of claim 1, wherein the voltage-limiting element comprises a varistor.

12. The circuit array of claim 5, wherein the second protective device comprises at least one of a spark gap, a varistor, and a Zener diode.

13. The circuit array of claim 11, wherein the varistor has a switching voltage that is less than 6 V.

14. The circuit array of claim 1, wherein the antenna input is connected to an antenna, the signal input is connected to a transmission amplifier, and the signal output is connected to a reception amplifier.

15. A circuit module comprising:
a circuit array comprising:
a first antenna input;
a signal input;
a signal output;
a switch unit that selectively connects the antenna input to either the signal input or the signal output, and
a protective device connected to the first antenna input, the protective device comprising a second antenna input connected to the first antenna input by a conductor, the protective device comprising a voltage-limiting element connected to a ground in parallel to the conductor; and
a multilayer ceramic substrate that includes integrated passive components that form frequency filters, wherein the switch unit is on an upper side of the ceramic substrate, the ceramic substrate including the the first protective device.

16. The circuit module of claim 15, wherein the circuit module is a front-end module in a mobile telephone.

17. A circuit array comprising:
a first antenna input;
a second antenna input; and
a protective device that connects the first antenna input to the second antenna input via a conductor, the protective device comprising a voltage-limiting element connected to a ground in parallel to the conductor.

18. The circuit array of claim 17, wherein the protective device comprises an inductor connected in parallel to the voltage-limiting element.

19. The circuit array of claim 17, wherein the protective device comprises:
a first inductor connected between the second antenna input and the voltage-limiting element in series with the conductor; and
a second inductor connected between the voltage-limiting element and the first antenna input in series with the conductor.

20. The circuit array of claim 17, wherein the protective device has an insertion loss <0.3 dB.

21. The circuit array of claim 17, wherein the voltage-limiting element comprises a varistor.

22. The circuit array of claim 21, wherein the varistor has a switching voltage that is less than 6 V.

23. The circuit array of claim 1, wherein the first protective device protects against electrostatic discharge.

24. The circuit array of claim 15, wherein the protective device protects against electrostatic discharge.

25. A circuit array comprising:
means for selectively connecting a first antenna input to a signal input or signal output by a switch unit; and
means for protecting the circuit array against electrostatic discharge, the means for protecting comprising a protective device, the protective device comprising a second antenna input connected to the first antenna input via a conductor, the first protective device comprising a voltage-limiting element connected to a ground in parallel to the conductor.
